(19) United States
(12) Patent Application Publication
(10) Pub. No.: US 2016/0359570 A1
(43) Pub. Date: Dec. 8, 2016

(54) MEASUREMENT SYSTEM FOR SEAS, RIVERS AND OTHER LARGE WATER BODIES

(71) Applicant: Umm Al-Qura University, Makkah (SA)

(72) Inventors: Emad FELEMBAN, Makkah (SA); Adil Amjad Ashraf Sheikh, Makkah (SA)

(73) Assignee: Umm Al-Qura University, Makkah (SA)

(21) Appl. No.: 14/728,664

(22) Filed: Jun. 2, 2015

(51) Int. Cl. H04B 11/00; G10K 11/00; G01S 19/13

(52) U.S. Cl. CPC H04B 11/00; G01S 19/13; G10K 11/006

(57) ABSTRACT

A sensor network system for seas, rivers and other large water bodies to measure at least one of water current, temperature, salinity, turbidity, viscosity, depth, light-intensity at various depths in the water body. The system includes water-bed sensor nodes, anchored sensor nodes and buoy sensor nodes, and at least one central station configured to collect sea water information from at least one of buoy sensor node, anchored sensor node, and sea-bed sensor nodes. The system analyzes the collected information to identify changes of surrounding water body and updates a water map based on the collected information.

### BACKGROUND

The demand for real-time integration data from earth has increased as the effects of global warming and associated climate change become more pronounced. Earth's oceans however, still remain under-sampled.

Accurate data relates to, but is not limited to, information such as flow velocities, turbulence, flow velocity variation with depth, and wave height. The highly dynamic nature of most water bodies makes it particularly difficult to take precise measurements. It also makes the deployment and recovery of survey instrumentation hazardous. Without the development of a viable deployment of sensors in a body of water there can be no live real-time feedback of data collected from bodies of water. Further, if physical retrieval of the sensors is required to obtain and analyze data, there will be delays in data acquisition as well as a significant waste of money and resources.

### SUMMARY

In an embodiment, a sensor network system for making measurements in a body of water, including:
one or more water-bed sensor nodes located on a water-bed and configured to measure attributes including at least one of water current, temperature, turbidity, viscosity, depth, and light-intensity at the water-bed at a first depth, one or more anchored sensor nodes connected to the water-bed and configured to measure at least one of the water current, the temperature, the turbidity, the viscosity, the depth, and the light-intensity at a second depth, and one or more buoy sensor nodes configured to float at or near a surface of the water, to receive measurement information from at least one of the one or more anchored sensor nodes and the one or more water-bed sensor nodes, and transmit the received information to a central station, the central station configured to
receive the measurement information from the at least one or more buoy sensor nodes, analyze the collected measurement information to identify changes of the attributes, determine whether the identified changes exceed an updating threshold based on the collected measurement information, and update a water map based on the measurement information and the updating threshold.

An embodiment, wherein at least one of the buoy sensor nodes includes a solar panel configured to produce power for the buoy sensor node.

An embodiment, wherein at least one of the buoy sensor nodes includes at least one GPS device and is configured to provide a location via beacon signals to at least one anchored sensor node for triangulation.

An embodiment, wherein at least one anchored sensor node is composed of a buoyant material and is connected via a wire to a motor configured to retract or release the wire to achieve a desired depth in the body of water.

An embodiment, wherein the one or more anchored sensor nodes includes an acoustic transceiver configured to determine the location of the one or more buoy sensor nodes by using Return Signal Strength Indication (RSSI) and triangulation, track the beacon signals when the one or more anchored sensor nodes are out of the beacon signal's range by using inertial measurement units, and collect and relay the measurement data received from at least one of the water-bed nodes and other anchored sensor nodes.

An embodiment, wherein the water-bed node includes an embedded location identifier to generate location information.

An embodiment, wherein the water-bed node is configured to transmit the measurement data through a direct wire to one or more buoy sensor nodes when the water-bed node is within a predetermined first distance of the one or more buoy sensor nodes, through an acoustic wireless transceiver directly to one or more buoy sensor nodes when the water-bed node is within a predetermined second distance, and through an acoustic wireless transceiver via the water-bed node to the one or more buoy sensor nodes when the distance between the one or more buoy sensor nodes and the water-bed node is greater than the second distance.

An embodiment, wherein the central station is located on a ship and is configured to receive and process data to provide a 3-D map of an area.

In an embodiment, a water measurement method implemented by a sensor network system including in part a central station, one or more buoy sensor nodes, one or more anchored sensor nodes and one or more water-bed sensor nodes, comprising:
measuring at a first depth, at one or more water-bed sensor nodes, attributes including at least one of water current, temperature, turbidity, viscosity, depth, and light-intensity in a body of water;
measuring at a second depth, at one or more anchored sensor nodes, the attributes including at least one of water current, temperature, turbidity, viscosity, depth, and light-intensity in a body of water;
receiving, at one or more buoy nodes, measurement information from at least one of the one or more of the anchored sensor nodes and the one or more water-bed sensor nodes, and transmitting the measurement information to the central station;
collecting, at the central station, the measurement information from the at least one buoy sensor node;
analyzing, at the central station via processing circuitry, the collected measurement information to identify changes within the of the attributes;
determining, at the central station and via the processing circuitry, whether the identified changes exceed an updating threshold based on the collected measurement information; and
updating, at the central station, a water map based on the collected measurement information and the updating threshold.

An embodiment, wherein the at least one anchored sensor node is composed of a buoyant material and is attached to a motor configured to retract and release a wire connected to the at least one anchored sensor.

An embodiment, wherein the at least one anchored sensor node includes an acoustic transceiver configured to determine the location of one or more buoy nodes by using Return Signal Strength Indication (RSSI) and triangulation, tracks beacon signals when of the at least one anchored sensor node when the at least one anchored sensor node is out of range by using inertial measurement units, and collects and relays data received from the at least one water-bed node and other anchored sensor nodes.

An embodiment, wherein the at least one water-bed node is configured to transmit accumulated data through a direct wire to one or more buoy sensor nodes within a first predetermined distance, through an acoustic wireless transceiver directly to one or more buoy sensor nodes when the one or more buoy sensor nodes are within a second predetermined distance, and through the acoustic wireless transceiver via one or more water-bed sink nodes to at least one buoy sensor node when the distance between the at least one buoy sensor nodes and the water-bed node is greater than the second distance.

### BRIEF DESCRIPTION OF THE DRAWINGS

FIG. 1 is a schematic diagram of one embodiment of a water measurement system according to one example;

FIG. 2 is a schematic diagram of an exemplary anchored node;

FIG. 3 is a schematic diagram of an exemplary direct wired communication between a sea-bed node and a buoy node;

FIG. 4 is a schematic diagram of an exemplary wireless communication between the sea-bed node and the buoy node;

FIG. 5 is a schematic diagram of an exemplary multihop wireless communication between the sea-bed node and the buoy node;

FIG. 6 is a flowchart diagram of the operation for automatically updating a three dimensional water body map according to one example;

FIG. 7 is a schematic diagram of an exemplary processing system according to one example.

### DETAILED DESCRIPTION

The use of underwater communication has become more commonplace as an increasing use of the waterways and oceans is made for various uses such as energy generation, trade, resource management, transport and leisure.

The deployment of devices underwater is becoming ever more important to service the requirements of underwater communications created by the use of the oceans and waterways. A system for measuring various information in a body of water provides numerous advantages. For example, commercial and recreational fishing agencies could use a body of water measurement system to determine the concentration of fish depending on the water currents. Recreational companies and adventure clubs could also use water body measurement systems to find out water current levels for surfing and various water sports. Marine Scientists and Researchers could use the water-body measurement system as a tool for enabling them to discover underwater resources which are of significant educational value. Naval Defense Agencies can also use the water-body measurement system to determine the current levels for effective functioning of submarines and efficient travel routes. In addition, emergency Response Forces can use the water-body measurement system to detect any unnatural underwater phenomenon in order to take preventive measures for emergency situations like underwater earthquakes and tsunamis.

In one embodiment, a current measurement system that is based on underwater sensor network (UWSN) is described herein. The disclosed system can measure water current as well as other values such as temperature, salinity, turbidity, viscosity, depth, light-intensity at various depths in the water body. Measurements are transmitted from the seabed and different water levels using sensing devices, up to the surface of water via wired and/or wireless media. This flexibility of the measurement system enhances the overall system capability as each medium is suited to support different distances between the sensing devices. The sensing devices mounted on buoys at the water surface can wirelessly transmit the data to central base stations on ships 107 or to land base stations 102. The ships 107 can also include underwater ships such as submarines and are not limited to surface ships. In select embodiments, the system provides a three dimensional map of the area under observation and its corresponding water current readings.

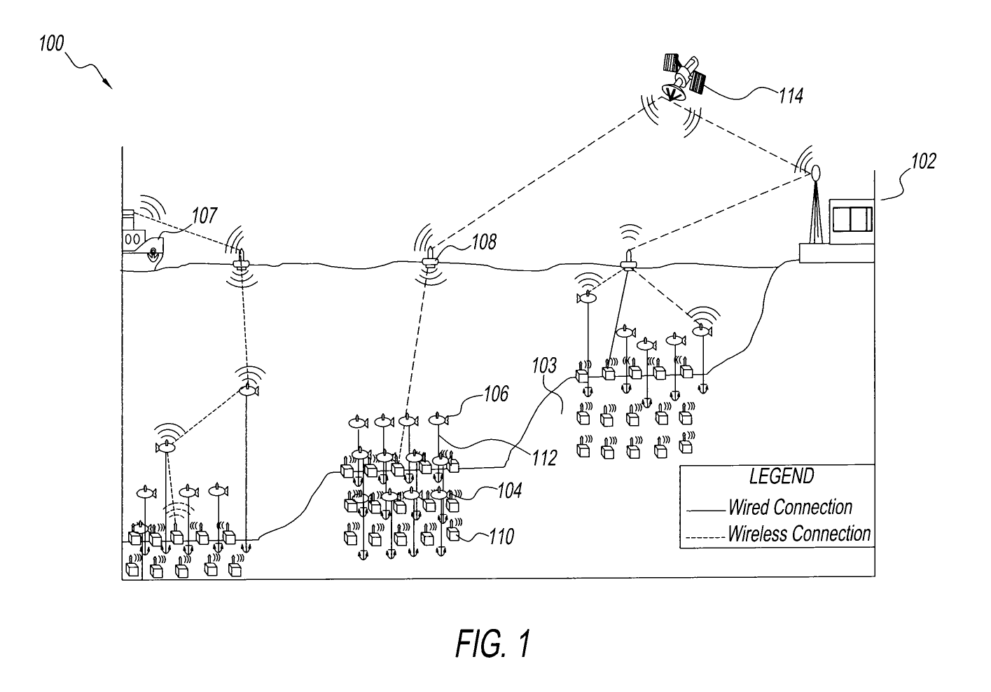

FIG. 1 illustrates an exemplary diagram of the water body measurement system. The marine measurement system 100 includes a central base station 102, and one or more types of sensor network nodes. The base station 102 is used to accumulate and process data coming from the sensor nodes. The one or more types of sensor network nodes include but are not limited to water-bed nodes 104 located on a waterbed 103, anchored nodes 106, and buoy nodes 108. In the example described herein, it will be assumed that the marine measurement system 100 is located in the sea and therefore has sea-bed nodes 104 located on a seabed 103. Thus, it is noted that the sea-bed nodes 104 are not limited to the sea and could be used in any body of water as a water-bed node 104 on a water-bed 103. Each sensor node is located in the environment and provides coverage for a certain range of area for observation. In select embodiments, each type of the sensor node includes a transceiver, a processor board, a battery to supply power and a water current measurement sensor. The sensor node can also contain other sensors that measure other information such as water temperature, pressure, depth, turbidity, and salinity as would be understood by one of ordinary skill in the art.

As shown in FIG. 1, the buoy nodes 108 are designed to float on the surface of the water. These nodes function as water surface sinks and are made of materials, such as Styrofoam designed to make the buoy node 108 float. They can receive data from the sea-bed nodes 104 and the anchored nodes 106. The buoy nodes 108 can also include Geographic Positioning System (GPS) circuitry such that the base station 102 can locate the buoy nodes 104 in the system 100 through the GPS. In select embodiments, the buoy nodes 108 can also provide their location as beacon signals to anchored nodes 106 for triangulation as would be understood by one of ordinary skill in the art. In trigonometry and geometry, the triangulation is the process of determining the location of a point by measuring angles to it from known points at either end of a fixed baseline, rather than measuring distances to the point directly. Moreover, the buoy nodes 108 communicate with the base station 102 through terrestrial communication such as GSM/3G/4G/Satellites 114. As seen in FIG. 1, the buoy nodes 108 can directly transmit to the base stations 102 as well as through satellite(s) 114. To provide power to the buoy nodes 108, the buoy nodes 108 can be tethered to a power cord located in the body of water or from land and/or the buoy nodes 108 can include energy harvesting equipment such as solar panels and wind energy devices.

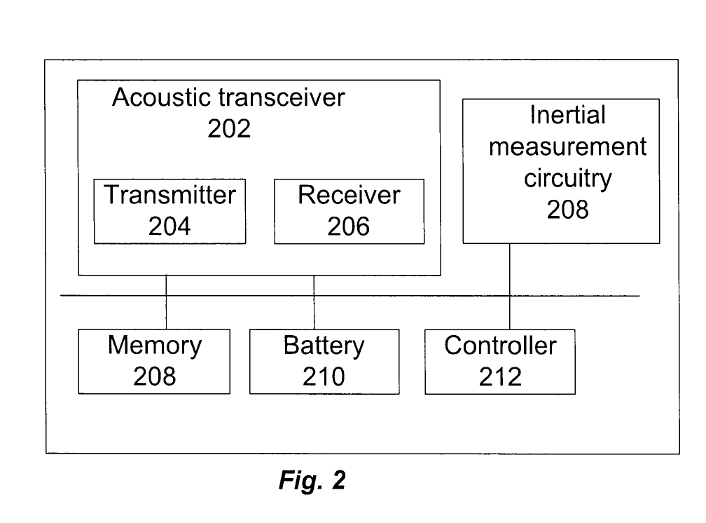

Exemplary embodiments of the anchored nodes 106, sea-bed nodes 104 and buoy nodes 108 are illustrated in FIG. 2. The anchored nodes 106 can be connected to the sea-bed 103 with an extendible wire 112 such that they can move up and down within the body of water. The shell of the anchored nodes 106 includes Styrofoam to provide buoyancy for the anchored nodes 106 therefore providing upward motion when additional wire 112 is provided. To adjust the wire 112, a motor 110 located on the seabed 103 can roll up and releases the wires 112 that connect the anchored nodes 106 to an anchor or the motor 110. The motor 110 can retrieve slack wire 112 thereby shortening the amount of slack wire 112 and lowering the relative depth of the anchored nodes 106. To conserve energy, the anchored nodes 106 can have an depth dispersion port which opens to receive liquid in response to the motor 110 sending a signal via wire 112 that the motor 110 will be retrieving slack wire 112. The motor 110 could be prompted to send this signal to the anchored node 106 in response to receiving a signal from one or more anchored nodes 106 and/or buoy nodes 108 based on information received from one or more of base station 102, ship 107 or extraterrestrial devices 114. In response to such a signal, the anchored node 106 can open the dispersion port to receive additional liquid thereby causing it to sink thereby conserving energy of the motor 110. Conversely, liquid can be emitted from the dispersion port when the motor 110 will be extending the wire so that the anchored node is more buoyant and moves to higher depths with the additional wire 112. Alternatively, the anchored node 106 may determine that it is not receiving a predetermined amount of information from the sensors and that it should be adjusted to a deeper or shallower depth to obtain additional readings. Accordingly, alternatively or in addition to the motor 110 sending a signal, the anchored node 106 may send a signal to the motor 110.

By releasing and shortening the wires 112, the anchored nodes 106 go to various adjustable depths to collect water current measurements and other sensor data. These depths can be set remotely from the base stations 102 or ships 107 via signals transmitted as described further herein. Alternatively, or in addition to, the anchored nodes 106 may be remotely operated or the anchored node itself can be an autonomous underwater vehicle have the ability to move to different depths, maintain position and anchor if necessary. In any case, the anchored nodes 106 can also determine at which height in the body of water to be located based on whether or not a signal is being received from at least one of another anchored node 106, buoy node 108, or sea-bed node 104 such that a particular communication network is created allowing signals to be sent to at least one of the base station 102, ship 107 and satellites 114.

As shown in FIG. 2 and in select embodiments, one or more of the anchored nodes 106, buoy nodes 108 and sea-bed nodes 104 includes an acoustic transceiver 202, a memory 208, a battery 210, a controller 212 and an inertial measurement circuitry 208. The acoustic transceiver 202 includes a transmitter 204 and a receiver 206. The acoustic transceiver 202 is used to communicate between the anchored nodes 106, sea-bed nodes 104 and buoy nodes 108 in order to broadcast messages or receive information. The anchored nodes 106 can triangulate their position using beacon signals from multiple buoy nodes 108. In one embodiment, the anchored nodes 106 use Return Signal Strength Indication (RSSI) and triangulation to determine the location of buoy nodes 108. For example, when the anchored node 106 receives beacon signals from buoy nodes 108, the receiver 206 determines location coordinates of the buoy node 108 based on the beacon signal and triangulation information, and the transmitter 204 transmits data to the discovered buoy node 108. The anchored nodes 106 can also include the inertial measurement circuitry 208 to track the location coordinates of the buoy node 108 when the anchored nodes 106 are out of beacon signal range. The inertial measurement circuitry 208 can include sensors such as accelerometers and gyroscopes that are used to track the position and orientation of an object relative to a known starting point, orientation and velocity. By processing signals from the accelerometers and gyroscopes, the inertial measurement circuitry 208 can track the position and orientation of the buoy node 108 without an external reference, such as beacon signals. The anchored nodes 106 also can also serve as data relay circuitry by collecting and relaying data they receive from the sea-bed nodes 104, that is stored in the memory 208, as well as other anchored nodes 106 or buoy nodes 108.

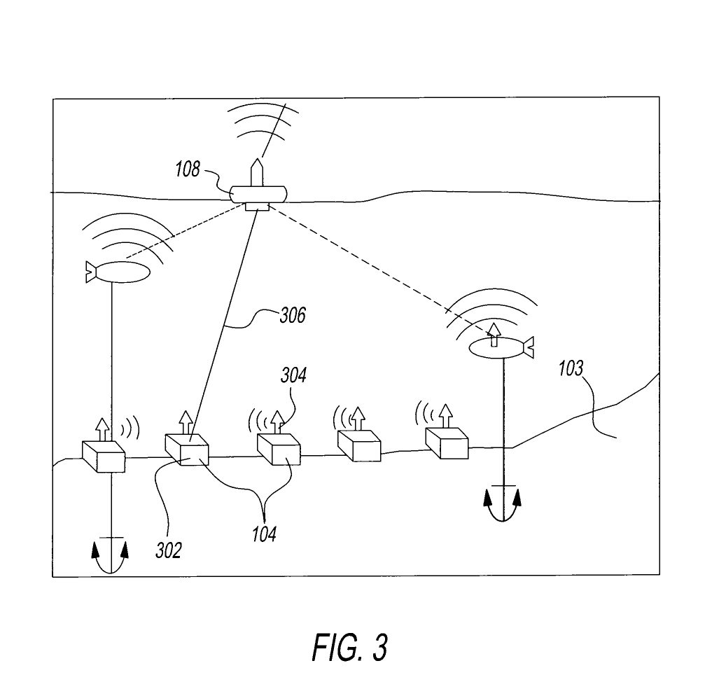

FIG. 3 illustrates sea-bed nodes 104 according to one example. In select embodiments, a sea-bed node 104 has the same hardware structure as the anchored nodes 106 described with respect to FIG. 2, and in some embodiments does not include the inertial measurement circuitry 208. As shown in FIG. 3, the sea-bed nodes 104 are located at the sea-bed 103 and can be anchored to the seabed via an anchor, fasteners or other attachment mechanism as would be understood by one of ordinary skill in the art. Each sea-bed node 104 can include sensors to measure current at the sea-bed 103, as well as other environmental factors such as salinity, pressure, and temperature. When sea-bed nodes 104 are placed at various locations, the location information can be saved in memory 208 for retrieval by the base stations 102, satellites 114 or ships 107. Therefore, the sea-bed nodes 104 can transmit to one or more anchor nodes 106 and/or buoy nodes 108 and/or other sea-bed nodes their measurement results along with their location information or a location ID thereby providing a picture of currents at various areas of the sea-bed 103.

In select embodiments, there are two subtypes of seabed nodes: a sea-bed source node 304 and a sea-bed sink node 302. The sea-bed source node 304 can have a short transmission range and can therefore be used for measurements and transmission towards other sea-bed nodes 104 within a predetermined range.

A number of sea-bed source nodes 304 and a sea-bed sink node 302 within a predetermine distance make a cluster. The sea-bed sink node 302 can accumulate measurements from neighboring sea-bed source nodes 304 and when a predetermined threshold of data accumulates in any particular sea-bed sink node 302 (according to, for example, the transmission bandwidth), the sea-bed sink node 302 transmits the data to one or more sea-bed sink nodes 302, one or more buoy nodes 108 and/or one or more anchored nodes 106. The predetermined threshold of data can also be determined when the controller 212 determines that various measurements have met a predetermined threshold value. For example, in one embodiment, the sea-bed sink node 302 will not transmit data to other sea-bed nodes 304, anchored nodes 106 or buoy nodes 109 until it has determine a particular water current value has remained relatively constant within an upper and lower bound and predetermined time period. This ensures that the sea-bed sink node 302 determines a consistent current rather than one that is constantly changing. In addition to, or alternatively, if the sea-bed sink node 302 sensors of the inertial measurement circuitry 208 do not detect a predetermined amount of consistent current after a predetermined period of time, this may trigger the sea-bed sink node 302 to transmit this information to the base station 102, ship 107 and/or satellites 114. This provides the advantageous information that the particular area of water does not have consistent current flow and therefore isn't very efficient as a sea lane route. It could also indicate that it is not a route along which a lot of sea life travels and therefore that it may not be a good place to capture sea life.

Sea-bed sink node transmission can be performed using one or more transmission mechanisms. FIG. 3 illustrates a short-range transmission method according to one example. As shown in FIG. 3, a sea-bed sink node 302 and sea-bed source nodes 304 are illustrated on the sea-bed 103. In one embodiment, and as illustrated in FIG. 3, the sea-bed sink node 302 is directly connected to the buoy node 108 via a direct wire 306. Accordingly, when the buoy node 108 is within a predetermined distance from the sea-bed sink node 302, the accumulated data can be transmitted via the direct wire connection 306 to the buoy node 108. A length of the direct wire 306 can be within a range, for example, of 1-10 meters but at additional distances can cause issues based on cost, water turbulence as well as being a safety hazard obstruction. Other lengths of the direct wire 306 can also be used based on the strength of the wire and the environment underneath the sea. For example, in a water environment with strong current, a shorter wire length is preferred than a longer wire to increase the stability of the system. The direct wire connection is a fastest method of data transfer to the buoy node 108 and therefore provides the advantage of quicker data acquisition by the base station 102, satellites 114 and/or ships 107.

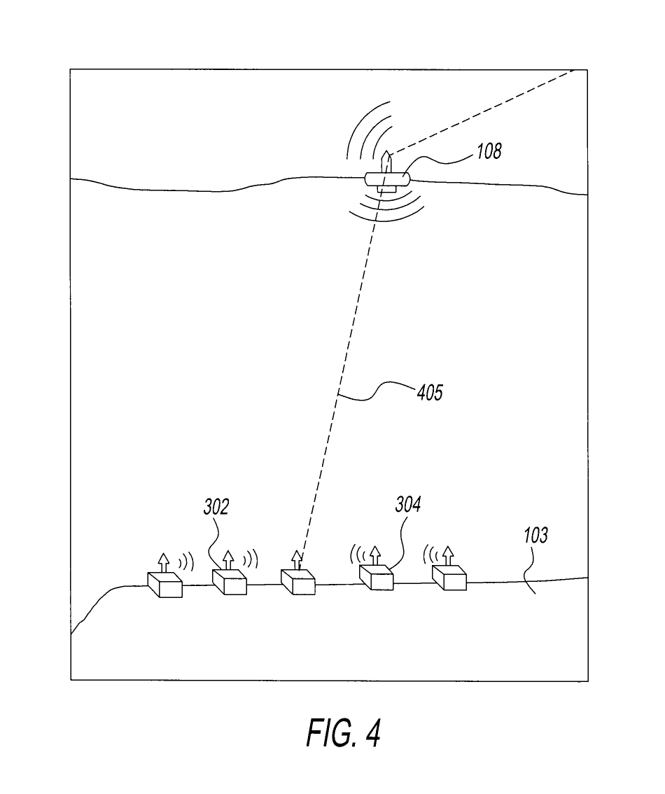

FIG. 4 shows a medium-range transmission method according to one example. In FIG. 4, sea-bed source nodes 304 are located on the sea-bed 103 with a sea-bed sink node 302 which are connected to the buoy node 108 via a wireless connection 405. When the buoy node 108 is not within a predetermined distance as described above for a wired connection and it is determined that no wired connection exists, the accumulated data is transmitted through the wireless connection 108 as shown in FIG. 4. The distance can be determined in a variety of ways. For example, the known location of the sea-bed source nodes 304 or sea-bed sink-nodes 302 determined based on triangulation can be compared to the location of the buoy node 108 to determine a distance therebetween. Additionally, a signal can be sent from the sea-bed sink node 302 to the buoy node 108 via the wireless connection 405 requesting a response from the buoy node 108 thereby determining a response time. This response time can be compared to various underwater variables such as temperature, salinity, pressure and other information to determine a transmission-response-time based distance in light of these factors. These methods can also be combined to determine an average distance between the two methodologies. Further, multiple measurements can be taken to determine an average distance based on the multiple readings within a predetermined time and if the values do not stay within a predetermined minumim threshold delta between measurements, the sea-bed sink node 302 circuitry will determine that transmissions should not be performed wirelessly directly to a buoy node 108 or that further measurements should be performed to ensure proper transmission. For example, if there is a lot of surface wind or current, a buoy node 108 may be going in and out of transmission range from a sea-bed sink node 302 such that ensuring proper transmission is difficult. In this case, the system can determine that wireless transmission to one or more intermediary sea-bed sink nodes 302 and/or anchored nodes 106 should be performed to ensure delivery to the buoy node 108.

The system can also prioritize transmission by determining which buoy node 108 is closest to the sea-bed sink node 302 based on a comparison of the distances and signal response times from various buoy nodes 108 based on a signal broadcast. The sea-bed sink node 302 can also broadcast to more than one buoy node 108 to increase the chances of data reception by the buoy node 108.

Accordingly, in one embodiment, if the sea-bed sink node 302 is located within in the acoustic range of the buoy node 108 based on the distance measurements, the medium-range transmission method is used. The communication is transmitted and received by an acoustic transceiver on each node. This method can be suitable for the medium distance ranges with a lower data rate, as it involves acoustic waves instead of electromagnetic waves.

Acoustic transceivers are suitable to be used underwater with low losses, at a sound velocity of approximately 1500 meters/second. One type of underwater transmission technique is a Long Base Line acoustic positioning (LBL) scheme. In most LBL schemes, the Device to Locate (DTL) is active and pings when it receives a sound. A signal sending device sends an acoustic signal to activate the DTL, and sender then receives the response ping and determines the time to the DTL. The roles of the sender and the receiver can be reversed.

A LBL system includes a number of transponder beacons in fixed locations on the seabed (or, for example, on buoys fixed to the sea bed), and an acoustic transducer in a transceiver that is installed in the central station. The positions of the beacons are described by a coordinate frame fixed to the seabed, and the distances between them form the system baselines. The distance from a transponder beacon to the transceiver is measured by causing the transducer to emit a short acoustic signal that the transponder detects and then responds to by transmitting an acoustic signal. The time from the transmission of the emitted signal to the reception of the detected signal is then measured. Since sound travels through water at a known speed, the distance between the transponder beacon and the transducer can then be estimated. The process is repeated for each of the remaining transponder beacons, allowing the position of the object relative to the array of beacons to be calculated or estimated.

Another type of underwater transmission technique is a Short Base Line (SBL) positioning scheme. A SBL system is normally fitted to a ship 107. A number of acoustic transducers are fitted in a triangle or rectangle on the lower part of the ship 107. There can be at least three transducers, but there could also be four or more transducers. The distance between the transducers (the baselines) is, typically a minimum of 10 meters. The position of each transducer within a co-ordinate frame fixed to the ship is determined from an “as built” survey of the ship.

SBL systems transmit from one, but receive on all transducers. The result is one distance (or range) measurement and a number of range (or time) differences. The distances from the transducers to an acoustic beacon are measured similar to what has been described for the LBL system. If redundant measurements are made, a best estimate can be calculated that is more accurate than a single position calculation. If it is necessary to estimate the position of a vessel in some fixed, or inertial, frame, then at least one beacon must be placed in a fixed position on the seabed and used as a reference point.

The transceiver can provide real-time communication of collected data to the shore base station 102. The transmitter may transmit data as soon as any data is collected from any of the sensors available on the buoy node 108, anchored nodes 106 and/or sea-bed nodes 304, or may buffer the data slightly, or may collect portions of data for batch transmission. The various nodes 104, 106 and 108 can include different types of transceiver (e.g. radio, microwave or other than acoustic transceiver) to send/receive different types of transmission. The transmission type may be chosen by the sensor data type being collected, or may be instructed by signal received by the transceiver from the central station. The transmitter, and or processor may be adapted to compress data before transmission. The node's transmitter system also comprises a receiver, to obtain instructions from another device, such as another buoy or the central station, and a processor to process the instructions and operate the instruction. For example, the central station may transmit instructions to the node, such as the buoy node 108, via a radio signal to change a deployment angle, and the processor may instruct a motor powering a rudder device to re-orientate the buoy node 108. The instructions may prompt the processor to (de)activate one or more of the sensors on board the buoy, or to activate them.

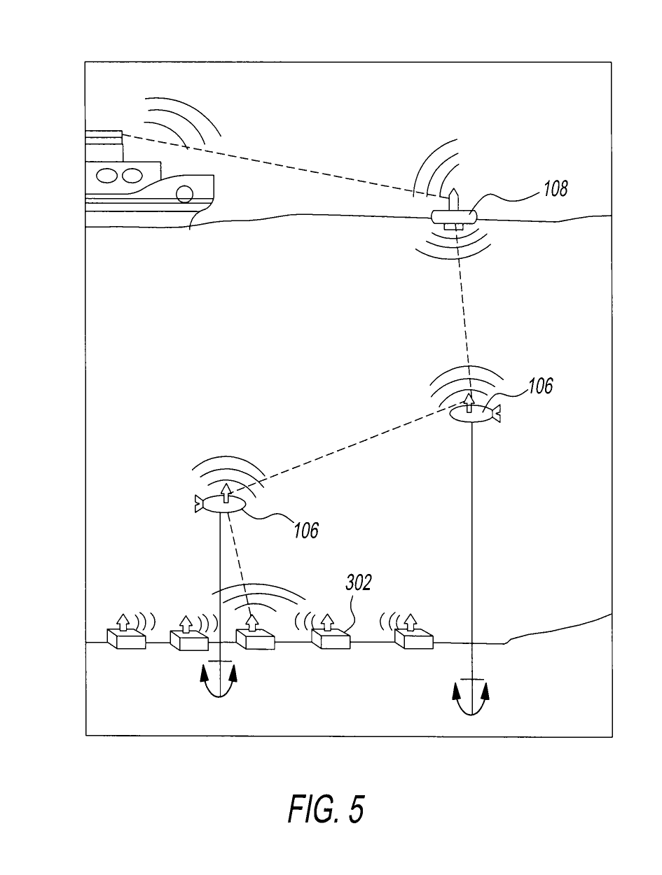

FIG. 5 shows a long-range transmission method. If the distance between sea-bed sink node 302 and the buoy node 108 is so high (for example, the distance between the sea-bed sink node 302 and the buoy node 108 is larger than 10 miles), that they are not within direct wireless transmission with each other, then the anchored nodes 106 serve as data relay agents. This is depicted in FIG. 5. This method will be used mainly for long distance communication. Alternatively, if as discussed above, multiple distance measurements are taken to determine an average distance to a buoy node 108 based on the multiple readings and if a predetermined maximum threshold delta between measurements is reached, the system will use long-range transmission. Each anchored node 106 is equipped with the acoustic transceiver as a data receiving link to capture and store data from the sea-bed sink node 302. The long-range transmission will have a slower data rate as compared to the short-range transmission and the medium-range transmission as it is dependent upon anchored nodes 106 relaying information from one or more sea-bed sink nodes 302. If the anchored node 106 is not within transmission range to the closest buoy node 108 but knows the location of the buoy node 108, the anchored node 106 as an autonomous vehicle as describes previously herein can relocate closer to the buoy node 108 to transmit the message.

The central base stations can be located on ships 107, sea-coast stations 102 or in space via satellites 114, and are responsible for receiving and processing data which will be relayed by the buoy nodes. This data consists of water current measurements, node location information and data from other sensors. The central base station processes the data to provide a 3-D map of the area where the system is installed.

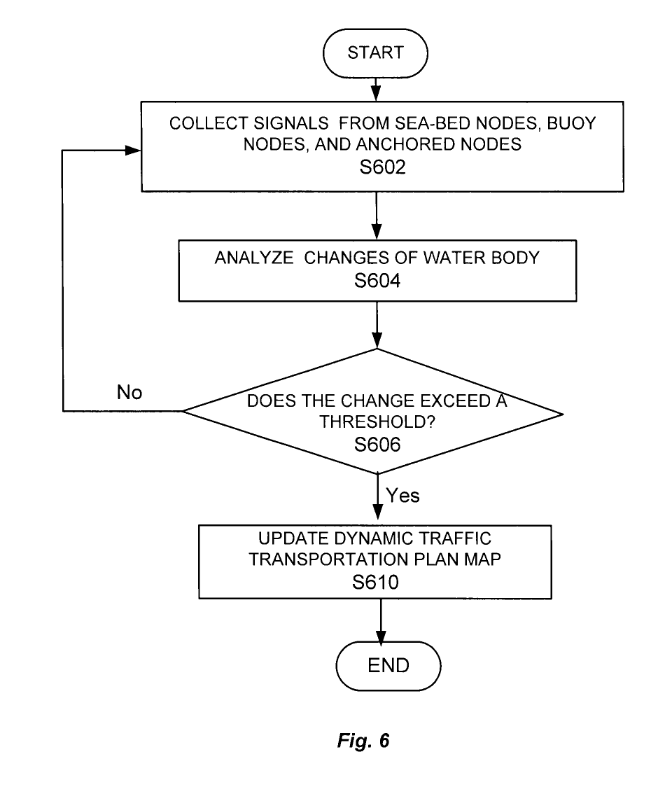

Referring to FIG. 6, a flowchart describing a method for automatically collecting and update 3-D water map according to one example is shown.

In step 602, processing circuitry of the central station collects signals emitted from one or more buoy nodes 108 which have been received by the one or more buoy nodes 108 via sea-bed sink nodes 302 and/or anchored nodes 106.

In step 604, processing circuitry of the central station analyzes the collected signals to identify changes of sea water environment. For example, in select embodiments, the central station can utilize the timing of signals and the position data received from the sensors over time to determine the direction of sea current in a particular area. Further, based on the determined direction of sea-current, the central station in select embodiments can filter the un-necessary information to only process sea water in a certain direction or within a certain geographic boundary.

In step 606, the processing circuitry of the central station determinates whether the sea water environment changes exceed an updating threshold indicating the water currents, the temperature, the salinity, and the turbidity of the water body within a predetermined area have significantly changed and that it should be reported. The updating threshold is set in advance and can be predetermined for various locations within a predefined geographic location and/or based on historical water body information for the region. Sea water currents are driven by three main factors. A first factor is the rise and fall of the tides. The tides create a current in the oceans, and a strongest tide is near the shore, in bays and estuaries along the coast. A second factor is winds. The winds drive currents that are near the ocean's surface. A third factor is thermohaline circulations. The thermohaline circulations process is driven by density difference in water due to temperature and salinity variations in different parts of the ocean. Accordingly, for places with high latitude, such as near Alaska, the updating threshold current is set higher than places with low latitude. For areas that have strong winds, such as in the suburb area, the updating threshold current is set higher than areas that have mild wind, such as inside the cities. For areas that are less polluted, such as polar area, the updating threshold turbidity is set higher than areas that are more polluted, such as inside the cities. For warm areas, such as near equator, the updating threshold temperature is set higher than areas that are less warm such as at frigid zones.

For example only the updating threshold of temperature may be set equal to approximately 30-40 F to eliminate surrounding environment temperature. Additional higher thresholds such as 60-80 F or higher threshold can be used instead of or in addition to the lower threshold. If multiple thresholds are employed, the threshold may be assigned a measure of certainty. In other words, at the winter, a lower updating threshold temperature can be used, such as below freezing. However, at the summer, a higher threshold such as 80 F may be used to reflect average temperature at this season. The updating threshold of current may be set equal to approximately 100-200 km/hour to eliminate unnecessary updating. Additional higher thresholds such as 700-800 km/hour or higher threshold can be used instead of or in addition to the lower threshold. If multiple thresholds are employed, the threshold may be assigned a measure of certainty. In other words, for cold currents, a higher triggering threshold value can be used. However, for warm currents, a lower threshold such as 100 km/hour may be used because usually the warm currents have lower speed. The updating threshold turbidity may be set equal to approximately 10-20 Nephelometric Turbidity Units (NTU) to eliminate unnecessary updating. Additional higher thresholds such as 40-50 NTU or higher threshold can be used instead of or in addition to the lower threshold. If multiple thresholds are employed, the threshold may be assigned a measure of certainty. In other words, in the places with lots pollution, a higher triggering threshold value can be used. However, in the places with less pollution, a lower threshold such as 15 NTU may be used because the water is cleaner there. The updating threshold of salinity may be set equal to approximately 30-35 ppt to eliminate unnecessary updating. Additional higher thresholds such as 45-50 ppt or higher threshold can be used instead of or in addition to the lower threshold. If multiple thresholds are employed, the threshold may be assigned a measure of certainty. In other words, at the equator area where the sea waters receive most rain (fresh water) on a consistent basis, a lower updating threshold value can be used. However, at the places with high evaporation or less rain, a higher threshold such as 50 ppt may be used.

In step 608, the processing circuitry calculates sea travel route information for based on the information obtained from step S606. For example, the system will know where currents are strong and where currents are weak and can devise updated shipping routes that can be sent to ships in various areas to enhance shipping times. GPS route direction systems could be used as would be understood by one of ordinary skill in the art to identify a travel route that is quickets while also avoiding certain lanes identified via the mapping. Also, in select embodiments at step S608, the processing circuitry updates a dynamic 3-D map based on the identified water currents, the temperature, the salinity, and the turbidity of the water body and the updating priorities to provide a 3D sea water map that users can use to learn the real-time sea-water information. The processing circuitry may selectively update the information for locations with a higher updating priority at an earlier time than for locations with a lower updating priority.

In select embodiments, a plurality of 3-D cameras can be attached to the buoy nodes 108, the anchored nodes 106, and the sea-bed nodes 104 to capture 3-D video data. Lens distance on camcorder is about 4 cm. Source data represents video data with parameters 1920×1080/25i. Firstly, image preprocessing on video data is performed. Preprocessing performs deinterlacing and decreasing the video resolution to final form of video—720p. The processing can involve a background subtraction around moving objects. This processing allows reduce noise and little unwished motion. This data can be used in step 5608 when updating route information or the dynamic 3-D map.

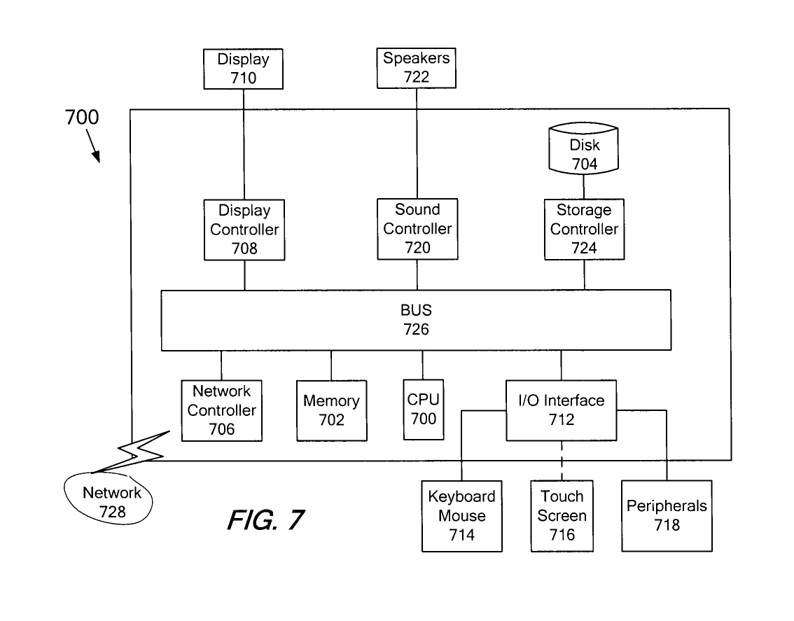

Next, a hardware description of each of one or more server devices operating at the central base station according to exemplary embodiments is described with reference to FIG. 7. In FIG. 7, the device includes the processing circuitry, or a CPU 700, which performs the processes described above. The process data and instructions may be stored in memory 702. These processes and instructions may also be stored on a storage medium disk 704 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device communicates, such as a server or computer.

Further, the claimed advancements may be provided as a utility application, background daemon, or component of an operating system, or combination thereof, executing in conjunction with CPU 700 and an operating system such as Microsoft Windows 7, UNIX, Solaris, LINUX, Apple MAC-OS and other systems known to those skilled in the art.

CPU 700 may be a Xenon or Core processor from Intel of America or an Opteron processor from AMD of America, or may be other processor types that would be recognized by one of ordinary skill in the art. Alternatively, the CPU 700 may be implemented on an FPGA, ASIC, PLD or using discrete logic circuits, as one of ordinary skill in the art would recognize. Further, CPU 700 may be implemented as multiple processors cooperatively working in parallel to perform the instructions of the inventive processes described above.

The device in FIG. 7 also includes a network controller 706, such as an Intel Ethernet PRO network interface card from Intel Corporation of America, for interfacing with network 728. As can be appreciated, the network 728 can be a public network, such as the Internet, or a private network such as an LAN or WAN network, or any combination thereof and can also include PSTN or ISDN sub-networks. The network 728 can also be wired, such as an Ethernet network, or can be wireless such as a cellular network including EDGE, 3G and 4G wireless cellular systems. The wireless network can also be WiFi, Bluetooth, or any other wireless form of communication that is known.

The device further includes a display controller 708, such as a NVIDIA GeForce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface also connects to a variety of peripherals 718 including printers and scanners, such as an OfficeJet or DeskJet from Hewlett Packard.

A sound controller 720 is also provided in the device, such as Sound Blaster X-Fi Titanium from Creative, to interface with speakers/microphone 722 hereby providing sounds and/or music. The general purpose storage controller 724 connects the storage medium disk 704 with communication bus 726, which may be an ISA, EISA, VESA, PCI, or similar, for interconnecting all of the components of the device. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, some implementations may be performed on modules or hardware not identical to those described. Accordingly, other implementations are within the scope that may be claimed.

1. A sensor network system for making measurements in a body of water, comprising:
one or more water-bed sensor nodes located on a water-bed and configured to measure attributes including at least one of water current, temperature, turbidity, viscosity, depth, and light-intensity at the water-bed at a first depth;
one or more anchored sensor nodes connected to the water-bed and configured to measure at least one of the water current, the temperature, the turbidity, the viscosity, the depth, and the light-intensity at a second depth;
one or more buoy sensor nodes configured to float at or near a surface of the water, to receive measurement information from at least one of the one or more anchored sensor nodes and the one or more water-bed sensor nodes, and transmit the received information to a central station,
the central station configured to
receive the measurement information from the at least one or more buoy sensor nodes,
analyze the collected measurement information to identify changes of the attributes,
determine whether the identified changes exceed an updating threshold based on the collected measurement information, and
update a water map based on the measurement information and the updating threshold.

2. The system of claim 1, wherein at least one of the buoy sensor nodes includes a solar panel configured to produce power for the buoy sensor node.

3. The system of claim 1, wherein at least one of the buoy sensor nodes includes at least one GPS device and is configured to provide a location via beacon signals to at least one anchored sensor node for triangulation.

4. The system of claim 1, wherein at least one anchored sensor node is composed of a buoyant material and is connected via a wire to a motor configured to retract or release the wire to achieve a desired depth in the body of water.

5. The system of claim 3, wherein the one or more anchored sensor nodes
includes an acoustic transceiver configured to determine the location of the one or more buoy sensor nodes by using Return Signal Strength Indication (RSSI) and triangulation,
track the beacon signals when the one or more anchored sensor nodes are out of the beacon signal's range by using inertial measurement units, and
collect and relay the measurement data received from at least one of the water-bed nodes and other anchored sensor nodes.

6. The system of claim 1, wherein the water-bed node includes an embedded location identifier to generate location information.

7. The system of claim 1, wherein the water-bed node is configured to transmit the measurement data through a direct wire to one or more buoy sensor nodes when the water-bed node is within a predetermined first distance of the one or more buoy sensor nodes, through an acoustic wireless transceiver directly to one or more buoy sensor nodes when the water-bed node is within a predetermined second distance, and through an acoustic wireless transceiver via the water-bed node to the one or more buoy sensor nodes when the distance between the one or more buoy sensor nodes and the water-bed node is greater than the second distance.

8. The system of claim 1, wherein the central station is located on a ship and is configured to receive and process data to provide a 3-D map of an area.

9. A water measurement method implemented by a sensor network system including in part a central station, one or more buoy sensor nodes, one or more anchored sensor nodes and one or more water-bed sensor nodes, comprising:
measuring at a first depth, at one or more water-bed sensor nodes, attributes including at least one of water current, temperature, turbidity, viscosity, depth, and light-intensity in a body of water;
measuring at a second depth, at one or more anchored sensor nodes, the attributes including at least one of water current, temperature, turbidity, viscosity, depth, and light-intensity in a body of water;
receiving, at one or more buoy nodes, measurement information from at least one of the one or more of the anchored sensor nodes and the one or more water-bed sensor nodes, and transmitting the measurement information to the central station;
collecting, at the central station, the measurement information from the at least one buoy sensor node;
analyzing, at the central station via processing circuitry, the collected measurement information to identify changes within the of the attributes;
determining, at the central station and via the processing circuitry, whether the identified changes exceed an updating threshold based on the collected measurement information; and
updating, at the central station, a water map based on the collected measurement information and the updating threshold.

10. The method of claim 9, wherein the at least one anchored sensor node is composed of a buoyant material and is attached to a motor configured to retract and release a wire connected to the at least one anchored sensor.

11. The method of claim 9, wherein the at least one anchored sensor node includes an acoustic transceiver configured to determine the location of one or more buoy nodes by using Return Signal Strength Indication (RSSI) and triangulation, tracks beacon signals when of the at least one anchored sensor node when the at least one anchored sensor node is out of range by using inertial measurement units, and collects and relays data received from the at least one water-bed node and other anchored sensor nodes.

12. The method of claim 11, wherein the at least one water-bed node is configured to transmit accumulated data through a direct wire to one or more buoy sensor nodes within a first predetermined distance, through an acoustic wireless transceiver directly to one or more buoy sensor nodes when the one or more buoy sensor nodes are within a second predetermined distance, and through the acoustic wireless transceiver via one or more water-bed sink nodes to at least one buoy sensor node when the distance between the at least one buoy sensor nodes and the water-bed node is greater than the second distance.
